(19) United States
(12) Patent Application Publication
(10) Pub. No.: US 2025/0254321 A1
(43) Pub. Date: Aug. 7, 2025

(54) Method and Apparatus Using Decoder-Derived Intra Prediction in Video Coding System

(71) Applicant: MEDIATEK INC., Hsinchu City (TW)

(72) Inventors: Chia-Ming TSAI, Hsinchu City (TW); Chun-Chia CHEN, Hsinchu City (TW); Man-Shu CHIANG, Hsinchu City (TW); Yu-Cheng LIN, Hsinchu City (TW); Chih-Wei HSU, Hsinchu City (TW); Tzu-Der CHUANG, Hsinchu City (TW); Ching-Yeh CHEN, Hsinchu City (TW); Yu-Wen HUANG, Hsinchu City (TW)

(21) Appl. No.: 18/853,206

(22) PCT Filed: Apr. 7, 2023
(86) PCT No.: PCT/CN2023/087052

§ 371 Date: Oct. 1, 2024

Related U.S. Application Data
(60) Provisional application No. 63/328,766, filed on Apr. 8, 2022.

(51) Int. Cl. H04N 19/139; H04N 19/105; H04N 19/119; H04N 19/174; H04N 19/176

(52) U.S. Cl. CPC H04N 19/139; H04N 19/105; H04N 19/119; H04N 19/174; H04N 19/176

(57) ABSTRACT

Methods and apparatus for video coding are disclosed. One method determines a prediction direction between vertical prediction and horizontal prediction for the current block based on a template of the current block or based on decoder side intra mode derivation (DIMD) using statistics or histogram of angle field derived from the template of the current block. According to another method, the current block is partitioned into a first region and a second region according to a region split. The first region is encoded or decoded based on inter coding. The second region is encoded or decoded according to intra coding. At least a part of region-spit parameters, a part of inter coding parameters, or a part of intra coding parameters are determined based on a template of the current block or based on DIMD using statistics or histogram of angle field derived from the template of the current block.

### CROSS REFERENCE TO RELATED APPLICATIONS

The present invention is a non-Provisional Application of and claims priority to U.S. Provisional Patent Application No. 63/328,766, filed on Apr. 8, 2022. The U.S. Provisional Patent Application is hereby incorporated by reference in its entirety.

### FIELD OF THE INVENTION

The present invention relates to intra prediction in a video coding system. In particular, the present invention relates to bit saving for coding parameters associated with Block Differential Pulse Coded Modulation (BDPCM) and inter-intra mixed GPM (Geometric Partition Mode).

### BACKGROUND

Versatile video coding (VVC) is the latest international video coding standard developed by the Joint Video Experts Team (JVET) of the ITU-T Video Coding Experts Group (VCEG) and the ISO/IEC Moving Picture Experts Group (MPEG). The standard has been published as an ISO standard: ISO/IEC 23090-3:2021, Information technology—Coded representation of immersive media—Part 3: Versatile video coding, published February 2021. VVC is developed based on its predecessor HEVC (High Efficiency Video Coding) by adding more coding tools to improve coding efficiency and also to handle various types of video sources including 3-dimensional (3D) video signals.

FIG. 1A illustrates an exemplary adaptive Inter/Intra video coding system incorporating loop processing. For Intra Prediction, the prediction data is derived based on previously coded video data in the current picture. For Inter Prediction 112, Motion Estimation (ME) is performed at the encoder side and Motion Compensation (MC) is performed based of the result of ME to provide prediction data derived from other picture(s) and motion data. Switch 114 selects Intra Prediction 110 or Inter-Prediction 112 and the selected prediction data is supplied to Adder 116 to form prediction errors, also called residues. The prediction error is then processed by Transform (T) 118 followed by Quantization (Q) 120. The transformed and quantized residues are then coded by Entropy Encoder 122 to be included in a video bitstream corresponding to the compressed video data. The bitstream associated with the transform coefficients is then packed with side information such as motion and coding modes associated with Intra prediction and Inter prediction, and other information such as parameters associated with loop filters applied to underlying image area. The side information associated with Intra Prediction 110, Inter prediction 112 and in-loop filter 130, are provided to Entropy Encoder 122 as shown in FIG. 1A. When an Inter-prediction mode is used, a reference picture or pictures have to be reconstructed at the encoder end as well. Consequently, the transformed and quantized residues are processed by Inverse Quantization (IQ) 124 and Inverse Transformation (IT) 126 to recover the residues. The residues are then added back to prediction data 136 at Reconstruction (REC) 128 to reconstruct video data. The reconstructed video data may be stored in Reference Picture Buffer 134 and used for prediction of other frames.

As shown in FIG. 1A, incoming video data undergoes a series of processing in the encoding system. The reconstructed video data from REC 128 may be subject to various impairments due to a series of processing. Accordingly, in-loop filter 130 is often applied to the reconstructed video data before the reconstructed video data are stored in the Reference Picture Buffer 134 in order to improve video quality. For example, deblocking filter (DF), Sample Adaptive Offset (SAO) and Adaptive Loop Filter (ALF) may be used. The loop filter information may need to be incorporated in the bitstream so that a decoder can properly recover the required information. Therefore, loop filter information is also provided to Entropy Encoder 122 for incorporation into the bitstream. In FIG. 1A, Loop filter 130 is applied to the reconstructed video before the reconstructed samples are stored in the reference picture buffer 134. The system in FIG. 1A is intended to illustrate an exemplary structure of a typical video encoder. It may correspond to the High Efficiency Video Coding (HEVC) system, VP8, VP9, H.264 or VVC.

The decoder, as shown in FIG. 1B, can use similar or portion of the same functional blocks as the encoder except for Transform 118 and Quantization 120 since the decoder only needs Inverse Quantization 124 and Inverse Transform 126. Instead of Entropy Encoder 122, the decoder uses an Entropy Decoder 140 to decode the video bitstream into quantized transform coefficients and needed coding information (e.g. ILPF information, Intra prediction information and Inter prediction information). The Intra prediction 150 at the decoder side does not need to perform the mode search. Instead, the decoder only needs to generate Intra prediction according to Intra prediction information received from the Entropy Decoder 140. Furthermore, for Inter prediction, the decoder only needs to perform motion compensation (MC 152) according to Inter prediction information received from the Entropy Decoder 140 without the need for motion estimation.

According to VVC, an input picture is partitioned into non-overlapped square block regions referred as CTUs (Coding Tree Units), similar to HEVC. Each CTU can be partitioned into one or multiple smaller size coding units (CUs). The resulting CU partitions can be in square or rectangular shapes. Also, VVC divides a CTU into prediction units (PUs) as a unit to apply prediction process, such as Inter prediction, Intra prediction, etc.

The VVC standard incorporates various new coding tools to further improve the coding efficiency over the HEVC standard. Among various new coding tools, some coding tools relevant to the present invention are reviewed as follows.

### Partitioning of the CTUs Using a Tree Structure

In HEVC, a CTU is split into CUs by using a quaternary-tree (QT) structure denoted as coding tree to adapt to various local characteristics. The decision whether to code a picture area using inter-picture (temporal) or intra-picture (spatial) prediction is made at the leaf CU level. Each leaf CU can be further split into one, two or four Pus according to the PU splitting type. Inside one PU, the same prediction process is applied and the relevant information is transmitted to the decoder on a PU basis. After obtaining the residual block by applying the prediction process based on the PU splitting type, a leaf CU can be partitioned into transform units (TUs) according to another quaternary-tree structure similar to the coding tree for the CU. One of key feature of the HEVC structure is that it has the multiple partition conceptions including CU, PU, and TU.

In VVC, a quadtree with nested multi-type tree using binary and ternary splits segmentation structure replaces the concepts of multiple partition unit types, i.e. it removes the separation of the CU, PU and TU concepts except as needed for CUs that have a size too large for the maximum transform length, and supports more flexibility for CU partition shapes. In the coding tree structure, a CU can have either a square or rectangular shape. A coding tree unit (CTU) is first partitioned by a quaternary tree (a.k.a. quadtree) structure. Then the quaternary tree leaf nodes can be further partitioned by a multi-type tree structure. As shown in FIG. 2, there are four splitting types in multi-type tree structure, vertical binary splitting (SPLIT_BT_VER 210), horizontal binary splitting (SPLIT_BT_HOR 220), vertical ternary splitting (SPLIT_TT_VER 230), and horizontal ternary splitting (SPLIT_TT_HOR 240). The multi-type tree leaf nodes are called coding units (CUs), and unless the CU is too large for the maximum transform length, this segmentation is used for prediction and transform processing without any further partitioning. This means that, in most cases, the CU, PU and TU have the same block size in the quadtree with nested multi-type tree coding block structure. The exception occurs when maximum supported transform length is smaller than the width or height of the colour component of the CU.

FIG. 3 illustrates the signalling mechanism of the partition splitting information in quadtree with nested multi-type tree coding tree structure. A coding tree unit (CTU) is treated as the root of a quaternary tree and is first partitioned by a quaternary tree structure. Each quaternary tree leaf node (when sufficiently large to allow it) is then further partitioned by a multi-type tree structure. In the multi-type tree structure, a first flag (mtt_split_cu_flag) is signalled to indicate whether the node is further partitioned; when a node is further partitioned, a second flag (mtt_split_cu_vertical_flag) is signalled to indicate the splitting direction, and then a third flag (mtt_split_cu_binary_flag) is signalled to indicate whether the split is a binary split or a ternary split. Based on the values of mtt_split_cu_vertical_flag and mtt_split_cu_binary_flag, the multi-type tree slitting mode (MttSplitMode) of a CU is derived as shown in Table 1.

TABLE 1
MttSplitMode derviation based on multi-type tree syntax elements

| | mtt_split_cu_vertical_{—} | mtt_split_cu_binary_{—} |
|---|---|---|
| MttSplitMode | flag | flag |
| SPLIT_TT_HOR | 0 | 0 |
| SPLIT_BT_HOR | 0 | 1 |
| SPLIT_TT_VER | 1 | 0 |
| SPLIT_BT_VER | 1 | 1 |

FIG. 4 shows a CTU divided into multiple CUs with a quadtree and nested multi-type tree coding block structure, where the bold block edges represent quadtree partitioning and the remaining edges represent multi-type tree partitioning. The quadtree with nested multi-type tree partition provides a content-adaptive coding tree structure comprised of CUs. The size of the CU may be as large as the CTU or as small as 4×4 in units of luma samples. For the case of the 4:2:0 chroma format, the maximum chroma CB size is 64×64 and the minimum size chroma CB consist of 16 chroma samples.

In VVC, the maximum supported luma transform size is 64×64 and the maximum supported chroma transform size is 32×32. When the width or height of the CB is larger the maximum transform width or height, the CB is automatically split in the horizontal and/or vertical direction to meet the transform size restriction in that direction.

The following parameters are defined and specified by SPS syntax elements for the quadtree with nested multi-type tree coding tree scheme.
CTU size: the root node size of a quaternary tree
MinQTSize: the minimum allowed quaternary tree leaf node size
MaxBtSize: the maximum allowed binary tree root node size
MaxTtSize: the maximum allowed ternary tree root node size
MaxMttDepth: the maximum allowed hierarchy depth of multi-type tree splitting from a quadtree leaf
MinBtSize: the minimum allowed binary tree leaf node size
MinTtSize: the minimum allowed ternary tree leaf node size

In one example of the quadtree with nested multi-type tree coding tree structure, the CTU size is set as 128×128 luma samples with two corresponding 64×64 blocks of 4:2:0 chroma samples, the MinQTSize is set as 16×16, the MaxBtSize is set as 128×128 and MaxTtSize is set as 64×64, the MinBtSize and MinTtSize (for both width and height) is set as 4×4, and the MaxMttDepth is set as 4. The quaternary tree partitioning is applied to the CTU first to generate quaternary tree leaf nodes. The quaternary tree leaf nodes may have a size from 16×16 (i.e., the MinQTSize) to 128×128 (i.e., the CTU size). If the leaf QT node is 128×128, it will not be further split by the binary tree since the size exceeds the MaxBtSize and MaxTtSize (i.e., 64×64). Otherwise, the leaf qdtree node could be further partitioned by the multi-type tree. Therefore, the quaternary tree leaf node is also the root node for the multi-type tree and it has multi-type tree depth (mttDepth) as 0. When the multi-type tree depth reaches MaxMttDepth (i.e., 4), no further splitting is considered. When the multi-type tree node has width equal to MinBtSize and smaller or equal to 2*MinTtSize, no further horizontal splitting is considered. Similarly, when the multi-type tree node has height equal to MinBtSize and smaller or equal to 2*MinTtSize, no further vertical splitting is considered.

To allow 64×64 Luma block and 32×32 Chroma pipelining design in VVC hardware decoders, TT split is forbidden when either width or height of a luma coding block is larger than 64, as shown in FIG. 5, where block 500 corresponds to a 128×128 luma CU. The CU can be split using vertical binary partition (510) or horizontal binary partition (520). After the block is split into 4 CUs, each size is 64×64, the CU can be further partitioned using partitions including TT. For example, the upper-left 64×64 CU is partitioned using vertical ternary splitting (530) or horizontal ternary splitting (540). TT split is also forbidden when either width or height of a chroma coding block is larger than 32.

In VVC, the coding tree scheme supports the ability for the luma and chroma to have a separate block tree structure. For P and B slices, the luma and chroma CTBs in one CTU have to share the same coding tree structure. However, for I slices, the luma and chroma can have separate block tree structures. When the separate block tree mode is applied, luma CTB is partitioned into CUs by one coding tree structure, and the chroma CTBs are partitioned into chroma CUs by another coding tree structure. This means that a CU in an I slice may consist of a coding block of the luma component or coding blocks of two chroma components, and a CU in a P or B slice always consists of coding blocks of all three colour components unless the video is monochrome.

### Virtual Pipeline Data Units (VPDUs)

Virtual pipeline data units (VPDUs) are defined as non-overlapping units in a picture. In hardware decoders, successive VPDUs are processed by multiple pipeline stages at the same time. The VPDU size is roughly proportional to the buffer size in most pipeline stages, so it is important to keep the VPDU size small. In most hardware decoders, the VPDU size can be set to maximum transform block (TB) size. However, in VVC, ternary tree (TT) and binary tree (BT) partition may lead to the increasing of VPDUs size.

In order to keep the VPDU size as 64×64 luma samples, the following normative partition restrictions (with syntax signalling modification) are applied in VTM, as shown in FIG. 6:
TT split is not allowed (as indicated by “X” in FIG. 6) for a CU with either width or height, or both width and height equal to 128.
For a 128×N CU with N≤64 (i.e. width equal to 128 and height smaller than 128), horizontal BT is not allowed.

For an N×128 CU with N≤64 (i.e. height equal to 128 and width smaller than 128), vertical BT is not allowed. In FIG. 6, the luma block size is 128×128. The dashed lines indicate block size 64×64. According to the constraints mentioned above, examples of the partitions not allowed are indicated by “X” as shown in various examples (610-680) in FIG. 6.

### Intra Mode Coding with 67 Intra Prediction Modes

To capture the arbitrary edge directions presented in natural video, the number of directional intra modes in VVC is extended from 33, as used in HEVC, to 65. The new directional modes not in HEVC are depicted as red dotted arrows in FIG. 7, and the planar and DC modes remain the same. These denser directional intra prediction modes apply for all block sizes and for both luma and chroma intra predictions.

In VVC, several conventional angular intra prediction modes are adaptively replaced with wide-angle intra prediction modes for the non-square blocks.

In HEVC, every intra-coded block has a square shape and the length of each of its side is a power of 2. Thus, no division operations are required to generate an intra-predictor using DC mode. In VVC, blocks can have a rectangular shape that necessitates the use of a division operation per block in the general case. To avoid division operations for DC prediction, only the longer side is used to compute the average for non-square blocks.

To keep the complexity of the most probable mode (MPM) list generation low, an intra mode coding method with 6 MPMs is used by considering two available neighbouring intra modes. The following three aspects are considered to construct the MPM list:
Default intra modes
Neighbouring intra modes
Derived intra modes.

A unified 6-MPM list is used for intra blocks irrespective of whether MRL and ISP coding tools are applied or not. The MPM list is constructed based on intra modes of the left and above neighbouring block. Suppose the mode of the left is denoted as Left and the mode of the above block is denoted as Above, the unified MPM list is constructed as follows:
When a neighbouring block is not available, its intra mode is set to Planar by default.
If both modes Left and Above are non-angular modes:
   MPM list→{Planar, DC, V, H, V−4, V+4}
If one of modes Left and Above is angular mode, and the other is non-angular:
   Set a mode Max as the larger mode in Left and Above
   MPM list→{Planar, Max, DC, Max−1, Max+1, Max−2}
If Left and Above are both angular and they are different:
   Set a mode Max as the larger mode in Left and Above
   if the difference of mode Left and Above is in the range of 2 to 62, inclusive
      MPM list→{Planar, Left, Above, DC, Max−1, Max+1}
   Otherwise
      MPM list→{Planar, Left, Above, DC, Max−2, Max+2}
If Left and Above are both angular and they are the same:
   MPM list→{Planar, Left, Left−1, Left+1, DC, Left−2}

Besides, the first bin of the MPM index codeword is CABAC context coded. In total three contexts are used, corresponding to whether the current intra block is MRL enabled, ISP enabled, or a normal intra block.

During 6 MPM list generation process, pruning is used to remove duplicated modes so that only unique modes can be included into the MPM list. For entropy coding of the 61 non-MPM modes, a Truncated Binary Code (TBC) is used.

In the present invention, method and apparatus are disclosed to further reduce data related to intra prediction.

### BRIEF SUMMARY OF THE INVENTION

A method and apparatus for video coding are disclosed. According to the method, pixel data associated with a current block at an encoder side or coded data associated with the current block to be decoded at a decoder side are received. A prediction direction between vertical prediction and horizontal prediction is determined for the current block based on a template of the current block or based on decoder side intra mode derivation using statistics or histogram of angle field derived from the template of the current block. The current block is encoded or decoded using BDPCM (Block Differential Pulse Coded Modulation) in the prediction direction. In one embodiment, the template comprises one or more sample lines in a neighbouring region of the current block.

According to another method, the current block is partitioned into a first region and a second region according to a region split. The first region is encoded or decoded based on inter coding. The second region is encoded or decoded according to intra coding. For the present method, at least a part of region-spit parameters, a part of inter coding parameters, or a part of intra coding parameters are determined based on a template of the current block or based on decoder side intra mode derivation using statistics or histogram of angle field derived from the template of the current block. In one embodiment, the template comprises one or more sample lines in a neighbouring region of the current block.

In one embodiment, a motion vector for the inter coding is derived using the template of the current block.

In one embodiment, an intra-prediction angle for the intra coding is derived using the template of the current block or the decoder side intra mode derivation.

In one embodiment, a partition boundary offset related to the region split is derived using the template of the current block. In one embodiment, information for a partition-boundary slope related to the region split is signalled in a bitstream at the encoder side. In one embodiment, information for a partition-boundary slope related to the region split is parsed from a bitstream at the decoder side.

### BRIEF DESCRIPTION OF THE DRAWINGS

FIG. 1A illustrates an exemplary adaptive Inter/Intra video coding system incorporating loop processing.

FIG. 1B illustrates a corresponding decoder for the encoder in FIG. 1A.

FIG. 2 illustrates examples of a multi-type tree structure corresponding to vertical binary splitting (SPLIT_BT_VER), horizontal binary splitting (SPLIT_BT_HOR), vertical ternary splitting (SPLIT_TT_VER), and horizontal ternary splitting (SPLIT_TT_HOR).

FIG. 3 illustrates an example of the signalling mechanism of the partition splitting information in quadtree with nested multi-type tree coding tree structure.

FIG. 4 shows an example of a CTU divided into multiple CUs with a quadtree and nested multi-type tree coding block structure, where the bold block edges represent quadtree partitioning and the remaining edges represent multi-type tree partitioning.

FIG. 5 shows an example of TT split forbidden when either width or height of a luma coding block is larger than 64.

FIG. 6 shows some examples of TT split forbidden when either width or height of a luma coding block is larger than 64.

FIG. 7 shows the intra prediction modes as adopted by the VVC video coding standard.

FIGS. 8A-B illustrate examples of wide-angle intra prediction a block with width larger than height (FIG. 8A) and a block with height larger than width (FIG. 8B).

FIG. 9 illustrates examples of two vertically-adjacent predicted samples using two non-adjacent reference samples in the case of wide-angle intra prediction.

FIG. 10A illustrates an example of selected template for a current block, where the template comprises T lines above the current block and T columns to the left of the current block.

FIG. 10B illustrates an example for T=3 and the HoGs (Histogram of Gradient) are calculated for pixels in the middle line and pixels in the middle column.

FIG. 10C illustrates an example of the amplitudes (ampl) for the angular intra prediction modes.

FIG. 11 illustrates an example of the blending process, where two intra modes (M1 and M2) and the planar mode are selected according to the indices with two tallest bars of histogram bars.

FIG. 12 illustrates an example of template-based intra mode derivation (TIMD) mode, where TIMD implicitly derives the intra prediction mode of a CU using a neighbouring template at both the encoder and decoder.

FIG. 13 illustrates an example of the of 64 partitions used in the VVC standard, where the partitions are grouped according to their angles and dashed lines indicate redundant partitions.

FIG. 14 illustrates an example of uni-prediction MV selection for the geometric partitioning mode.

FIG. 15 illustrates an example of bending weight ω₀ using the geometric partitioning mode.

FIG. 16A illustrates an example of the inter-intra mixed GPM mode, where an occluded object is uncovering from back of another object.

FIG. 16B illustrates an example of the inter-intra mixed GPM mode applied to a current block.

FIG. 17A illustrates an example of inter-intra mixed GPM according to an embodiment of the present invention, where a template is used to derive information related to partition region, inter coding or intra coding.

FIG. 17B illustrates an example of template used for deriving parameters for inter coding and intra coding.

FIG. 18 illustrates an exemplary process of the inter-intra mixed GPM according to an embodiment of the present invention.

FIG. 19 illustrates an example of determining between vertical binary partition and horizontal binary partition using TIMD or DIMD according to an embodiment of the present invention.

FIG. 20 illustrates a flowchart of an exemplary video coding system that derives partition mode for BDPCM using TIMD/DIMD according to an embodiment of the present invention.
FIG. 21 illustrates a flowchart of an exemplary video coding system that derives coding parameters related inter-intra GPM using TIMD/DIMD according to an embodiment of the present invention.

### DETAILED DESCRIPTION OF THE INVENTION

It will be readily understood that the components of the present invention, as generally described and illustrated in the figures herein, may be arranged and designed in a wide variety of different configurations. Thus, the following more detailed description of the embodiments of the systems and methods of the present invention, as represented in the figures, is not intended to limit the scope of the invention, as claimed, but is merely representative of selected embodiments of the invention. References throughout this specification to “one embodiment,” “an embodiment,” or similar language mean that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment. Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention. The illustrated embodiments of the invention will be best understood by reference to the drawings, wherein like parts are designated by like numerals throughout. The following description is intended only by way of example, and simply illustrates certain selected embodiments of apparatus and methods that are consistent with the invention as claimed herein.

### Wide-Angle Intra Prediction for Non-Square Blocks

Conventional angular intra prediction directions are defined from 45 degrees to −135 degrees in clockwise direction. In VVC, several conventional angular intra prediction modes are adaptively replaced with wide-angle intra prediction modes for non-square blocks. The replaced modes are signalled using the original mode indexes, which are remapped to the indexes of wide angular modes after parsing. The total number of intra prediction modes is unchanged, i.e., 67, and the intra mode coding method is unchanged.

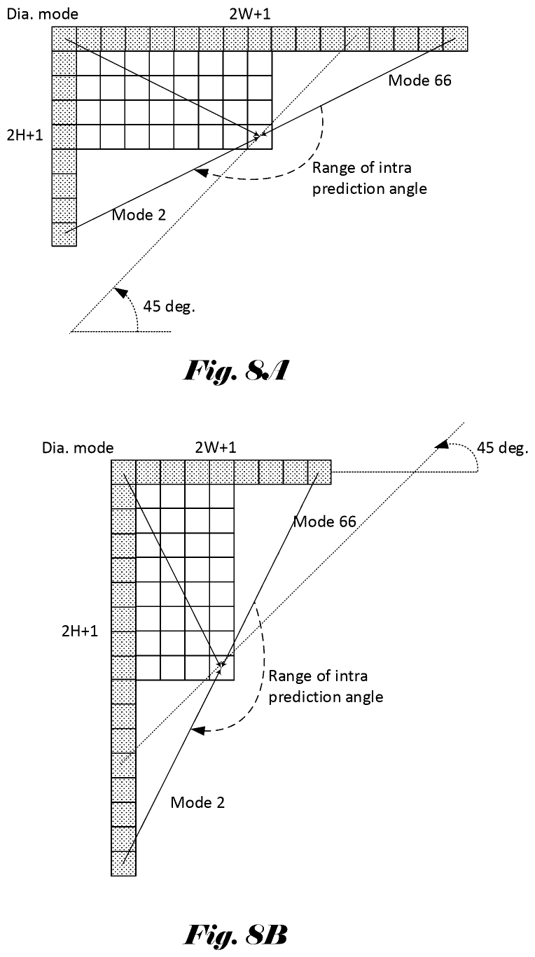

To support these prediction directions, the top reference with length 2W+1, and the left reference with length 2H+1, are defined as shown in FIG. 8A and FIG. 8B respectively.

The number of replaced modes in wide-angular direction mode depends on the aspect ratio of a block. The replaced intra prediction modes are illustrated in Table 2.

TABLE 2
Intra prediction modes replaced by wide-angular modes

| Aspect ratio | Replaced intra prediction modes |
|---|---|
| W/H == 16 | Modes 12, 13, 14, 15 |
| W/H == 8 | Modes 12, 13 |
| W/H == 4 | Modes 2, 3, 4, 5, 6, 7, 8, 9, 10, 11 |
| W/H == 2 | Modes 2, 3, 4, 5, 6, 7, |
| W/H == 1 | None |
| W/H == 1/2 | Modes 61, 62, 63, 64, 65, 66 |
| W/H == 1/4 | Mode 57, 58, 59, 60, 61, 62, 63, 64, 65, 66 |
| W/H == 1/8 | Modes 55, 56 |
| W/H == 1/16 | Modes 53, 54, 55, 56 |

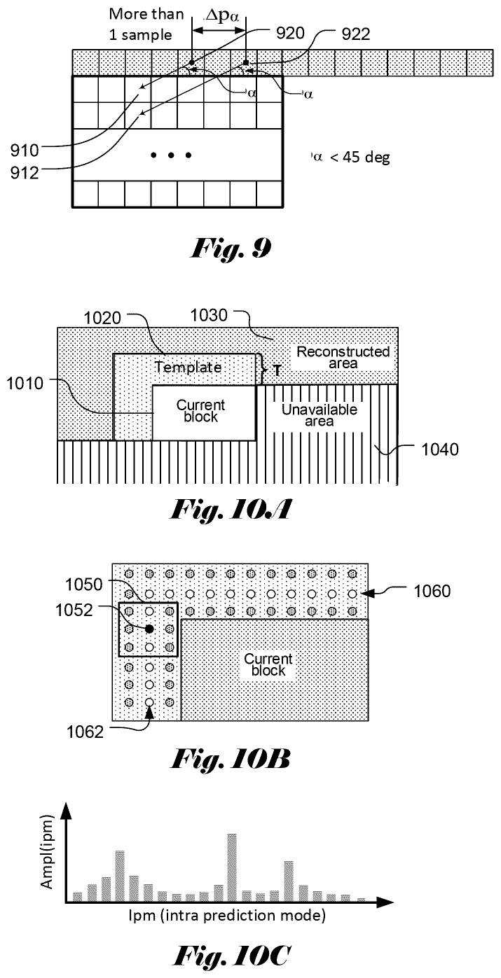

As shown in FIG. 9, two vertically-adjacent predicted samples (samples 910 and 912) may use two non-adjacent reference samples (samples 920 and 922) in the case of wide-angle intra prediction. Hence, low-pass reference samples filter and side smoothing are applied to the wide-angle prediction to reduce the negative effect of the increased gap Δp_{α}. If a wide-angle mode represents a non-fractional offset. There are 8 modes in the wide-angle modes satisfy this condition, which are [−14, −12, −10, −6, 72, 76, 78, 80]. When a block is predicted by these modes, the samples in the reference buffer are directly copied without applying any interpolation. With this modification, the number of samples needed to be smoothing is reduced. Besides, it aligns the design of non-fractional modes in the conventional prediction modes and wide-angle modes.

In VVC, 4:2:2 and 4:4:4 chroma formats are supported as well as 4:2:0. Chroma derived mode (DM) derivation table for 4:2:2 chroma format was initially ported from HEVC extending the number of entries from 35 to 67 to align with the extension of intra prediction modes. Since HEVC specification does not support prediction angle below −135° and above 45°, luma intra prediction modes ranging from 2 to 5 are mapped to 2. Therefore, chroma DM derivation table for 4:2:2: chroma format is updated by replacing some values of the entries of the mapping table to convert prediction angle more precisely for chroma blocks.

### 4-Tap Interpolation Filter and Reference Sample Smoothing

Four-tap intra interpolation filters are utilized to improve the directional intra prediction accuracy. In HEVC, a two-tap linear interpolation filter has been used to generate the intra prediction block in the directional prediction modes (i.e., excluding Planar and DC predictors). In VVC, the two sets of 4-tap IFs (interpolation filters) replace lower precision linear interpolation as in HEVC, where one is a DCT-based interpolation filter (DCTIF) and the other one is a 4-tap smoothing interpolation filter (SIF). The DCTIF is constructed in the same way as the one used for chroma component motion compensation in both HEVC and VVC. The SIF is obtained by convolving the 2-tap linear interpolation filter with [1 2 1]/4 filter.

Depending on the intra prediction mode, the following reference samples processing is performed:

The directional intra-prediction mode is classified into one of the following groups:
Group A: vertical or horizontal modes (HOR_IDX, VER_IDX),
Group B: directional modes that represent non-fractional angles (−14, −12, −10, −6, 2, 34, 66, 72, 76, 78, 80,) and Planar mode,
Group C: remaining directional modes;

If the directional intra-prediction mode is classified as belonging to group A, then no filters are applied to the reference samples to generate the predicted samples;

Otherwise, if a mode falls into group B and the mode is a directional mode, and all of following conditions are true, then a [1, 2, 1] reference sample filter may be applied (depending on the MDIS condition) to the reference samples to further copy these filtered values into an intra predictor according to the selected direction, but no interpolation filters are applied:
refIdx is equal to 0 (no MRL)
TU size is greater than 32
Luma
No ISP block

Otherwise, if a mode is classified as belonging to group C, MRL index is equal to 0, and the current block is not ISP block, then only an intra reference sample interpolation filter is applied to reference samples to generate a predicted sample that falls into a fractional or integer position between reference samples according to a selected direction (no reference sample filtering is performed). The interpolation filter type is determined as follows:
Set minDistVerHor equal to Min(Abs(predModeIntra−50), Abs(predModeIntra−18))
Set nTbS equal to (Log2(W)+Log2(H))>>1
Set intraHorVerDistThres[nTbS] as specified below:

| | nTbS = 2 | nTbS = 3 | nTbS = 4 | nTbS = 5 | nTbS = 6 | nTbS = 7 |
|---|---|---|---|---|---|---|
| intraHorVerDistThres[nTbS] | 24 | 14 | 2 | 0 | 0 | 0 |

If minDistVerHor is greater than intraHorVerDistThres[nTbS], SIF is used for the interpolation
Otherwise, DCTIF is used for the interpolation

### Decoder Side Intra Mode Derivation (DIMD)

When DIMD is applied, two intra modes are derived from the reconstructed neighbour samples, and those two predictors are combined with the planar mode predictor with the weights derived from the gradients. The DIMD mode is used as an alternative prediction mode and is always checked in the high-complexity RDO mode.

To implicitly derive the intra prediction modes of a blocks, a texture gradient analysis is performed at both the encoder and decoder sides. This process starts with an empty Histogram of Gradient (HoG) with 65 entries, corresponding to the 65 angular modes. Amplitudes of these entries are determined during the texture gradient analysis.

In the first step, DIMD picks a template of T=3 columns and lines from respectively left side and above side of the current block. This area is used as the reference for the gradient based intra prediction modes derivation.

In the second step, the horizontal and vertical Sobel filters are applied on all 3×3 window positions, centered on the pixels of the middle line of the template. At each window position, Sobel filters calculate the intensity of pure horizontal and vertical directions as Gₓ and G_{y}, respectively. Then, the texture angle of the window is calculated as:

$$angle = arctan ( {G}_{x} / {G}_{y} ) , \qquad ( 1 )$$

which can be converted into one of 65 angular intra prediction modes. Once the intra prediction mode index of current window is derived as idx, the amplitude of its entry in the HoG[idx] is updated by addition of:

$$ampl = \vert {G}_{x} \vert + \vert {G}_{y} \vert \qquad ( 2 )$$

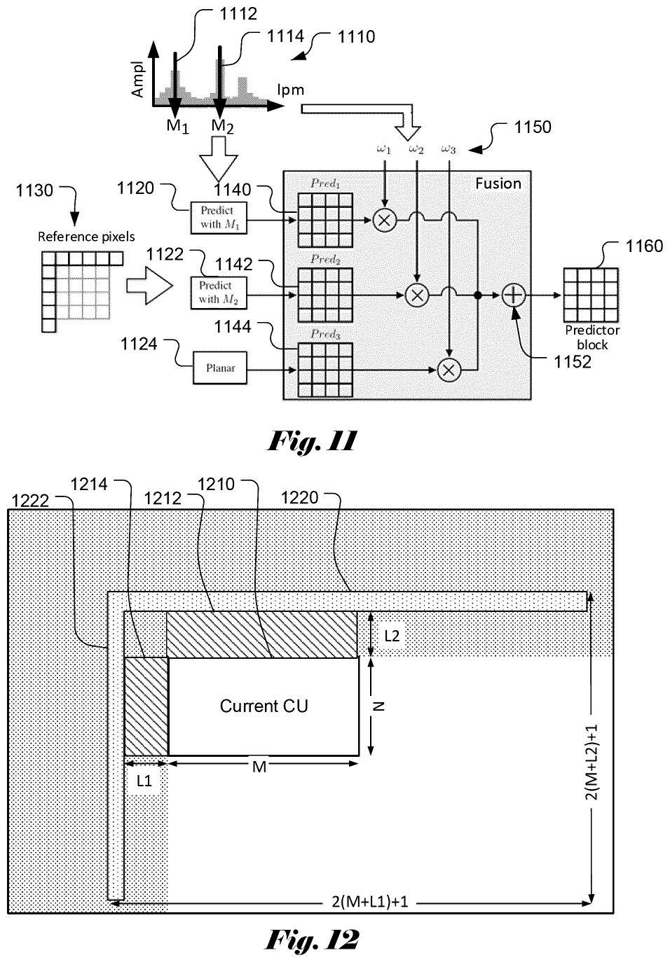

FIGS. 10A-C show an example of HoG, calculated after applying the above operations on all pixel positions in the template. FIG. 10A illustrates an example of selected template 1020 for a current block 1010. Template 1020 comprises T lines above the current block and T columns to the left of the current block. For intra prediction of the current block, the area 1030 at the above and left of the current block corresponds to a reconstructed area and the area 1040 below and at the right of the block corresponds to an unavailable area. FIG. 10B illustrates an example for T=3 and the HoGs are calculated for pixels 1060 in the middle line and pixels 1062 in the middle column. For example, for pixel 1052, a 3×3 window 1050 is used. FIG. 10C illustrates an example of the amplitudes (ampl) calculated based on equation (2) for the angular intra prediction modes as determined from equation (1).

Once HoG is computed, the indices with two tallest histogram bars are selected as the two implicitly derived intra prediction modes for the block and are further combined with the Planar mode as the prediction of DIMD mode. The prediction fusion is applied as a weighted average of the above three predictors. To this aim, the weight of planar is fixed to 21/64 (˜⅓). The remaining weight of 43/64 (˜⅔) is then shared between the two HoG IPMs, proportionally to the amplitude of their HoG bars. FIG. 11 illustrates an example of the blending process. As shown in FIG. 11, two intra modes (m1 1112 and M2 1114) are selected according to the indices with two tallest bars of histogram bars 1110. The three predictors (1140, 1142 and 1144) are used to form the blended prediction. The three predictors correspond to applying the M1, M2 and planar intra modes (1120, 1122 and 1124 respectively) to the reference pixels 1130 to form the respective predictors. The three predictors are weighted by respective weighting factors (ω₁, ω₂ and ω₃) 1150. The weighted predictors are summed using adder 1152 to generated the blended predictor 1160.

Besides, the two implicitly derived intra modes are included into the MPM list so that the DIMD process is performed before the MPM list is constructed. The primary derived intra mode of a DIMD block is stored with a block and is used for MPM list construction of the neighbouring blocks.

### Template-Based Intra Mode Derivation (TIMD)

Template-based intra mode derivation (TIMD) mode implicitly derives the intra prediction mode of a CU using a neighbouring template at both the encoder and decoder, instead of signalling the intra prediction mode to the decoder. As shown in FIG. 12, the prediction samples of the template (1212 and 1214) for the current block 1210 are generated using the reference samples (1220 and 1222) of the template for each candidate mode. A cost is calculated as the SATD (Sum of Absolute Transformed Differences) between the prediction samples and the reconstruction samples of the template. The intra prediction mode with the minimum cost is selected as the DIMD mode and used for intra prediction of the CU. The candidate modes may be 67 intra prediction modes as in VVC or extended to 131 intra prediction modes. In general, MPMs can provide a clue to indicate the directional information of a CU. Thus, to reduce the intra mode search space and utilize the characteristics of a CU, the intra prediction mode can be implicitly derived from the MPM list.

For each intra prediction mode in MPMs, the SATD between the prediction and reconstruction samples of the template is calculated. First two intra prediction modes with the minimum SATD are selected as the TIMD modes. These two TIMD modes are fused with weights after applying PDPC process, and such weighted intra prediction is used to code the current CU. Position dependent intra prediction combination (PDPC) is included in the derivation of the TIMD modes.

The costs of the two selected modes are compared with a threshold, in the test, the cost factor of 2 is applied as follows:

costMode2<2*costMode1.

If this condition is true, the fusion is applied, otherwise only mode1 is used. Weights of the modes are computed from their SATD costs as follows:

$$\begin{matrix}weight 1 = costMode 2 / ( costMode 1 + costMode 2 ) \\ weight 2 = 1 - weight 1.\end{matrix}$$

### Block Differential Pulse Coded Modulation (BDPCM)

VVC supports block differential pulse coded modulation (BDPCM) for screen content coding. At the sequence level, a BDPCM enable flag is signalled in the SPS; this flag is signalled only if the transform skip mode is enabled in the SPS.

When BDPCM is enabled, a flag is transmitted at the CU level if the CU size is smaller than or equal to MaxTsSize by MaxTsSize in terms of luma samples and if the CU is intra coded, where MaxTsSize is the maximum block size for which the transform skip mode is allowed. This flag indicates whether regular intra coding or BDPCM is used. If BDPCM is used, a BDPCM prediction direction flag is transmitted to indicate whether the prediction is horizontal or vertical. Then, the block is predicted using the regular horizontal or vertical intra prediction process with unfiltered reference samples. The residual is quantized and the difference between each quantized residual and its predictor, i.e. the previously coded residual of the horizontal or vertical (depending on the BDPCM prediction direction) neighbouring position, is coded.

For a block of size M (height)×N (width), let rᵢⱼ, 0≤i≤M−1, 0≤j≤N−1 be the prediction residual. Let Q(rᵢⱼ), 0≤i≤M−1, 0≤j≤N−1 denote the quantized version of the residual r_{i,j}. BDPCM is applied to the quantized residual values, resulting in a modified M×N array \tilde{R} with elements \tilde{r}_{i,j}, where \tilde{r}_{i,j} is predicted from its neighbouring quantized residual value. For vertical BDPCM prediction mode, for 0≤j≤(N−1), the following is used to derive \tilde{r}_{i,j}:

$${\tilde{r}}_{i , j} = \{ \begin{matrix}Q ( {r}_{i , j} ) , & i = 0 \\ Q ( {r}_{i , j} ) - Q ( {r}_{( i - 1 ) , j} ) , & 1 \leq i \leq ( M - 1 )\end{matrix} \qquad ( 3 )$$

For horizontal BDPCM prediction mode, for 0≤i≤(M−1), the following is used to derive \tilde{r}_{i,j}:

$${\tilde{r}}_{i , j} = \{ \begin{matrix}Q ( {r}_{i , j} ) , & j = 0 \\ Q ( {r}_{i , j} ) - Q ( {r}_{i , ( j - 1 )} ) , & 1 \leq j \leq ( N - 1 )\end{matrix} \qquad ( 4 )$$

At the decoder side, the above process is reversed to compute Q(r_{i,j}), 0≤i≤M−1, 0≤j≤N−1, as follows:

$$Q ( {r}_{i , j} ) = {\sum }_{k = 0}^{i} {\tilde{r}}_{k , j} , if vertical BDPCM is used \qquad ( 5 )$$

$$Q ( {r}_{i , j} ) = {\sum }_{k = 0}^{j} {\tilde{r}}_{i , k} , if horizontal BDPCM is used \qquad ( 6 )$$

The inverse quantized residuals, Q⁻¹ (Q(r_{i,j})), are added to the intra block prediction values to produce the reconstructed sample values.

The predicted quantized residual values \tilde{r}_{i,j} are sent to the decoder using the same residual coding process as that in transform skip mode residual coding. For lossless coding, if slice_ts_residual_coding_disabled_flag is set to 1, the quantized residual values are sent to the decoder using regular transform residual coding. In terms of the MPM mode for future intra mode coding, horizontal or vertical prediction mode is stored for a BDPCM-coded CU if the BDPCM prediction direction is horizontal or vertical, respectively. For deblocking, if both blocks on the sides of a block boundary are coded using BDPCM, then that particular block boundary is not deblocked.

### Geometric Partitioning Mode (GPM)

In VVC, a Geometric Partitioning Mode (GPM) is supported for inter prediction as described in JVET-W2002 (Adrian Browne, et al., Algorithm description for Versatile Video Coding and Test Model 14 (VTM 14), ITU-T/ISO/IEC Joint Video Exploration Team (JVET), 23rd Meeting, by teleconference, 7-16 Jul. 2021, document: document JVET-M2002). The geometric partitioning mode is signalled using a CU-level flag as one kind of merge mode, with other merge modes including the regular merge mode, the MMVD mode, the CIIP mode and the subblock merge mode. A total of 64 partitions are supported by geometric partitioning mode for each possible CU size, w×h=2^{m}×2ⁿ with m, n∈{3 . . . 6} excluding 8×64 and 64×8. The GPM mode can be applied to skip or merge CUs having a size within the above limit and having at least two regular merge modes.

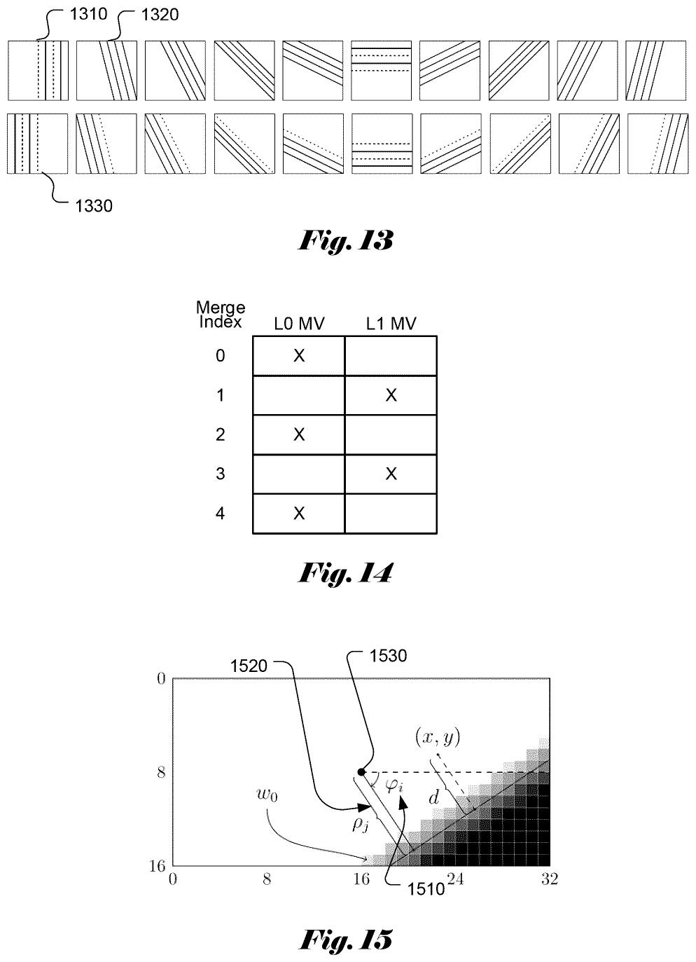

When this mode is used, a CU is split into two parts by a geometrically located straight line in certain angles. In VVC, there are a total of 20 angles and 4 offset distances used for GPM, which has been reduced from 24 angles in an earlier draft. The location of the splitting line is mathematically derived from the angle and offset parameters of a specific partition. In VVC, there are a total of 64 partitions as shown in FIG. 13, where the partitions are grouped according to their angles and dashed lines indicate redundant partitions. Each part of a geometric partition in the CU is inter-predicted using its own motion; only uni-prediction is allowed for each partition, that is, each part has one motion vector and one reference index. In FIG. 13, each line corresponds to the boundary of one partition. The partitions are grouped according to its angle. For example, partition group 1310 consists of three vertical GPM partitions (i.e., 90°). Partition group 1320 consists of four slant GPM partitions with a small angle from the vertical direction. Also, partition group 1330 consists of three vertical GPM partitions (i.e., 270°) similar to those of group 1310, but with an opposite direction. The uni-prediction motion constraint is applied to ensure that only two motion compensated prediction are needed for each CU, same as the conventional bi-prediction. The uni-prediction motion for each partition is derived using the process described later.

If geometric partitioning mode is used for the current CU, then a geometric partition index indicating the selected partition mode of the geometric partition (angle and offset), and two merge indices (one for each partition) are further signalled. The number of maximum GPM candidate size is signalled explicitly in SPS (Sequence Parameter Set) and specifies syntax binarization for GPM merge indices. After predicting each of part of the geometric partition, the sample values along the geometric partition edge are adjusted using a blending processing with adaptive weights using the process described later. This is the prediction signal for the whole CU, and transform and quantization process will be applied to the whole CU as in other prediction modes. Finally, the motion field of a CU predicted using the geometric partition modes is stored using the process described later.

### Uni-Prediction Candidate List Construction

The uni-prediction candidate list is derived directly from the merge candidate list constructed according to the extended merge prediction process. Denote n as the index of the uni-prediction motion in the geometric uni-prediction candidate list. The LX motion vector of the n-th extended merge candidate (X=0 or 1, i.e., LX=L0 or L1), with X equal to the parity of n, is used as the n-th uni-prediction motion vector for geometric partitioning mode. These motion vectors are marked with “x” in FIG. 14. In case a corresponding LX motion vector of the n-the extended merge candidate does not exist, the L(1−X) motion vector of the same candidate is used instead as the uni-prediction motion vector for geometric partitioning mode.

### Blending Along the Geometric Partitioning Edge

After predicting each part of a geometric partition using its own motion, blending is applied to the two prediction signals to derive samples around geometric partition edge. The blending weight for each position of the CU are derived based on the distance between individual position and the partition edge.

The distance for a position (x, y) to the partition edge are derived as:

$$d ( x , y ) = ( 2 x + 1 - w ) cos ( {φ}_{i} ) + ( 2 y + 1 - h ) sin ( {φ}_{i} ) - {ρ}_{j} \qquad ( 7 )$$

$${ρ}_{j} = {ρ}_{x , j} cos ( {φ}_{i} ) + {ρ}_{y , j} sin ( {φ}_{i} ) \qquad ( 8 )$$

$${ρ}_{x , j} = \{ \begin{matrix}0 & i \% 16 = 8 or ( i \% 16 \neq 0 and h \geq w ) \\ \pm ( j \times w ) >> 2 & otherwise\end{matrix} \qquad ( 9 )$$

$${ρ}_{y , j} = \{ \begin{matrix}\pm ( j \times w ) >> 2 & i \% 16 = 8 or ( i \% 16 \neq 0 and h \geq w ) \\ 0 & otherwise\end{matrix} \qquad ( 10 )$$

where i, j are the indices for angle and offset of a geometric partition, which depend on the signaled geometric partition index. The sign of ρ_{x,j} and ρ_{y,j} depend on angle index i.

The weights for each part of a geometric partition are derived as following:

$$wIdxL ( x , y ) = partIdx ? 32 + d ( x , y ) : 32 - d ( x , y ) \qquad ( 11 )$$

$${w}_{0} ( x , y ) = \frac{Clip 3 ( 0 , 8 , ( wIdxL ( x , y ) + 4 ) ≫ 3 )}{8} \qquad ( 12 )$$

$${w}_{1} ( x , y ) = 1 - {w}_{0} ( x , y ) \qquad ( 13 )$$

The partIdx depends on the angle index i. One example of weigh w₀ is illustrated in FIG. 15, where the angle φᵢ 1510 and offset ρᵢ 1520 are indicated for GPM index i and point 1530 corresponds to the center of the block.

### Motion Field Storage for Geometric Partitioning Mode

Mv1 from the first part of the geometric partition, Mv2 from the second part of the geometric partition and a combined MV of Mv1 and Mv2 are stored in the motion filed of a geometric partitioning mode coded CU.

The stored motion vector type for each individual position in the motion filed are determined as:

$$s T y p e = abs ( motionIdx ) < 32 ? 2 : ( motionIdx \leq 0 ? ( 1 - partIdx ) : partIdx ) \qquad ( 14 )$$

where motionIdx is equal to d(4x+2, 4y+2), which is recalculated from equation (2). The partIdx depends on the angle index i.

If sType is equal to 0 or 1, Mv0 or Mv1 are stored in the corresponding motion field, otherwise if sType is equal to 2, a combined MV from Mv0 and Mv2 are stored. The combined Mv are generated using the following process:
1) If Mv1 and Mv2 are from different reference picture lists (one from L0 and the other from L1), then Mv1 and Mv2 are simply combined to form the bi-prediction motion vectors.
2) Otherwise, if Mv1 and Mv2 are from the same list, only uni-prediction motion Mv2 is stored.

### Proposed Method A: Implicit Signalling for BDPCM

It is proposed to apply DIMD or TIMD to BDPCM to achieve implicit signalling for BDPCM, which is one of the coding tools in VVC standard.

In BDPCM, there are two modes: horizontal and vertical. In one embodiment of the present invention, we can use DIMD or TIMD to estimate which mode to be used for the current block and spare the need for signalling the BDPCM direction flag.

Since BDPCM only has two directions to support, it is easy to estimate the direction based on DIMD (or TIMD). It may have a significant benefit for screen content compression since the overhead associated with the flag (i.e., for BDPCM direction) may be large. Accordingly, saving one flag may have a substantial benefit in improving the compression efficiency.

### Proposed Method B: Template Based Inter-Intra Mixed GPM Mode

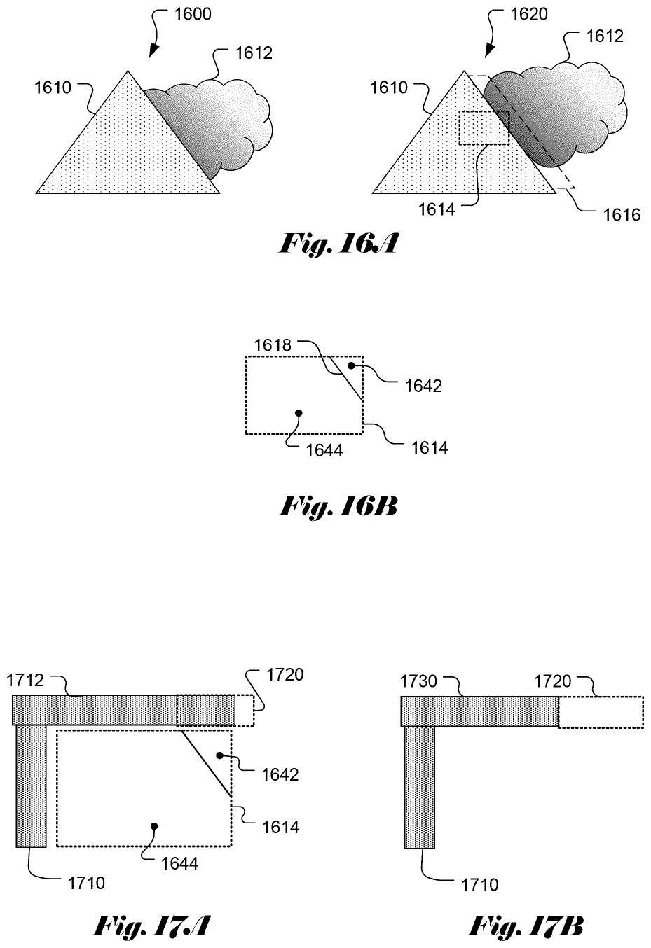

An example of the inter-intra mixed GPM mode is illustrated in FIG. 16A, where the scene 1600 illustrates an exemplary scene in a reference picture and scene 1620 illustrates the corresponding scene in the current picture. Object 1610 (shown as a triangle) corresponds to an object in the front and object 1612 (shown as a cloud shape) corresponds to a moving object behind object 1610. Block 1614 is a current block in the current picture. FIG. 16B illustrates the inter-intra mixed GPM processing for current block 1614, where partition 1644 of the current block 1614 corresponds to stationary portion of object 1610 and another partition 1642 of the current block 1614 corresponds to the uncovered area of the moving object from occlusion. The partition line 1618 between the two portions corresponds to an edge of object 1610. To code the current block efficiently, it needs to apply intra-coding to the partition uncovered (i.e., partition 1642) and apply inter-coding to partition 1644. The reason for the intra-coding part is that the content cannot find any corresponding content in the reference picture due to occlusion.

The inter-intra mixed GPM mode is similar to VVC GPM mode. However, in VVC GPM mode, both partitions are all coded in the inter-mode. In the inter-intra mixed GPM mode, one partition is coded in the intra mode and another partition is coded in the inter mode.

Since occlusion cases are very common in moving object, an occlusion-resolving coding mode will largely increase the coding gain, i.e., the inter-intra mixed GPM mode will have a large benefit for this kind of content.

For the inter-intra mixed GPM mode, the encoder needs to send side-information of the inter coding part (e.g. candidate index, MVD, and so on) and the intra-coding part (e.g. prediction angle, intra-mode, and so on). In order to save the syntax overhead, we propose the TIMD/DIMD based method for the inter-intra mixed GPM mode according to embodiments of the present invention.

In the proposed method, it only sends region-split information (similar to GPM syntax), and uses L-template-based method to derive the MV for the inter-coding part. For the intra-coding part, it can use DIMD/TIMD based method to derive the intra-prediction angle. One example is shown in FIGS. 17A-B, where the intra-angle can be predicted in the decoder side to decide the intra-prediction-angle for the intra-coding partition. For the intra-coded partition 1642, the L-shaped template (1710 and 1712) may not be reliable since they may correspond to the front object (i.e., object 1610). Accordingly, only a portion of the top template (as shown by the dotted box 1720) is used to derive the intra-prediction angle for the intra-coded partition 1642 as shown in FIG. 17A. For the inter-coded partition 1644, a portion of the top template (i.e., template 1720) corresponds to the uncovered portion of the moving object, which may not provide a reliable reference to derive the MV. Accordingly, only the portion of the top template above the inter-coded partition 1644 (i.e., template 1730 in FIG. 17B) is used with the left template 1710 to derive the MV. In another embodiment, we can reduce the overhead related to the partition information for the inter-intra mixed GPM mode by using inter-L-template matching (e.g. comparing the current L-neighbouring reconstructed samples and the reference L-neighbouring samples). As shown in FIGS. 17A-B, the encoder only needs to send the partition-boundary slope (i.e., the angle index in VVC GPM), without the need for sending the partition boundary offset (i.e., the distance-index in VVC GPM). In other words, only information related to the partition-boundary slope is signalled in the bitstream at the encoder side or parsed from the bitstream at the decoder side. The decoder can derive the partition boundary offset by inter-L-template matching. For example, in FIG. 17B, some region on the top-neighbouring part may be occluded (e.g. region 1720), which causes large distortion in inter-L-template matching for this occlusion region in FIG. 17B. Accordingly, the decoder can observe this and decide the partition offset.

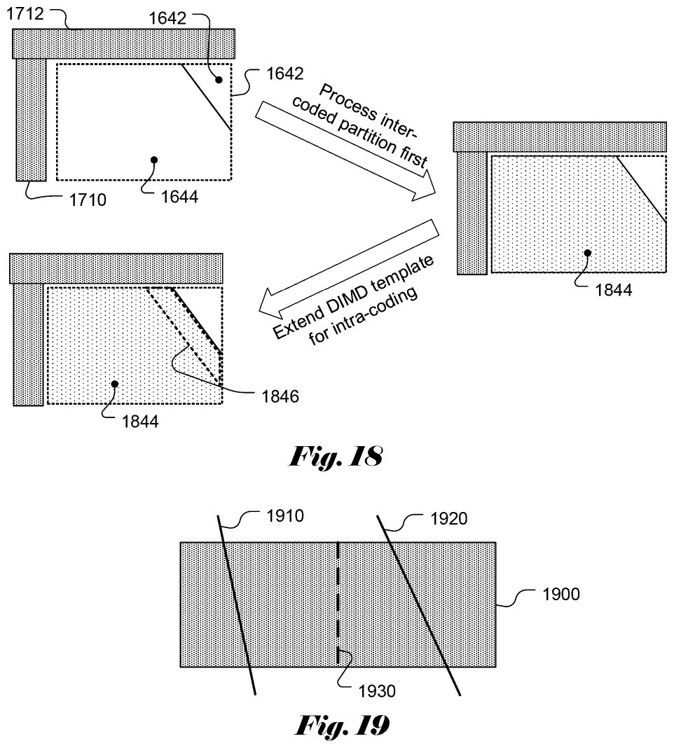

In another embodiment, we can have more surrounding reconstructed pixels (or predicted pixels) for the intra-coding partition in the inter-intra mixed GPM mode. An example of this proposed method is shown in FIG. 18. In FIG. 18, inter-coding is applied to the inter-coded partition 1644 first to generate the reconstructed inter-coded partition 1844. After the inter-coded partition is reconstructed, intra-coding is then applied to the intra-coded partition 1642. When intra-coding is applied to the intra-coded partition, the neighbouring reconstructed (or predicted) pixels in the neighbouring region 1846 within the inter-coded partition 1844 are available for the intra prediction. Accordingly, we have an extended template (i.e., region 1846) for DIMD that can be used to derive parameters related to the intra-coding. In another embodiment, the intra-coding can refer to the result of inter-coding partition (prediction samples or reconstructed samples) for the intra prediction. In another embodiment, it can apply TIMD or DIMD on the inter-coding region to assist a more accurate angle for the intra-coding region. In this technique, the transform kernel needs to be properly designed according to the new residual distribution.

### Proposed Method C: DIMD to Save Split Flag

In this proposed method, we can use DIMD or TIMD to estimate the split direction in the decoder side. The decoder can assume different tree-partition versions and apply DIMD or TIMD, to calculate the related distortion and guess the decided partition mode according to the distortions.

Take BT (Binary Tree) as an example. In the decoder side, it can assume the partition is one of HBT (Horizontal BT) or VBT (Vertical BT), and have two child CUs based on this assumption. Next, by applying DIMD or TIMD on both child CUs, the decided angles of DIMD or TIMD can further help to construct the “outer predicted samples” (i.e., predicted samples in the L-neighbouring region outside the current CU). By comparing the “outer predicted samples” with the L-neighbouring reconstructed samples, we can determine the distortion. By comparing the distortions of HBT assumption and VBT assumption, the decoder can derive the partition direction (without receiving the split direction flag from the encoder).

The same method can be applied to other split methods, such as QT (quad-tree), TT (Ternary Tree), ABT (Asymmetric BT), etc.

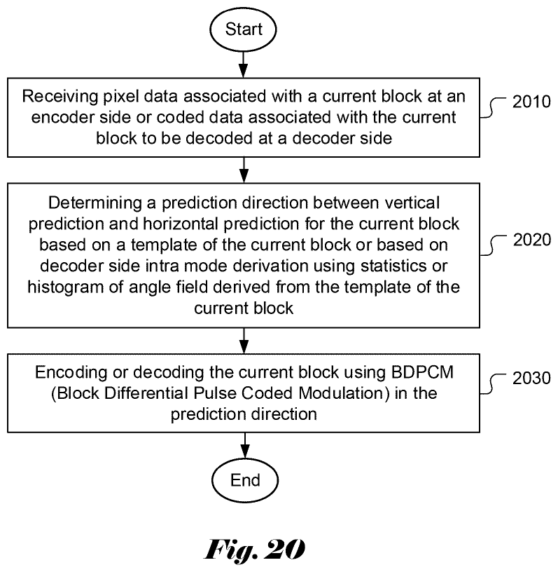

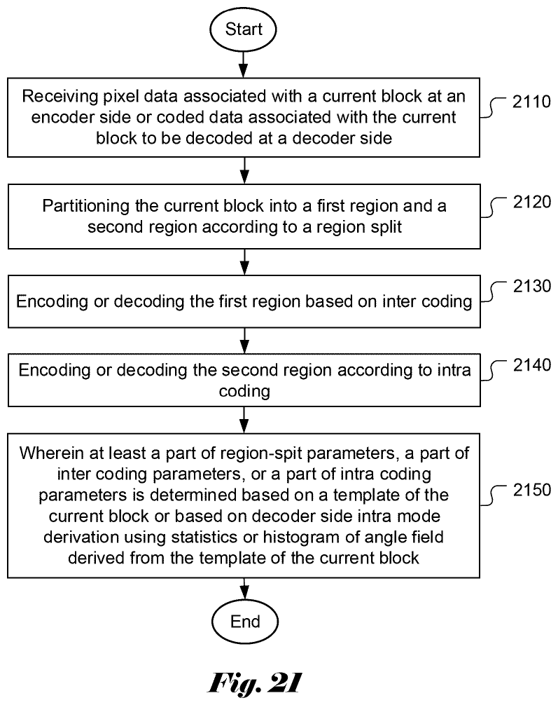

In another embodiment, by analysing the content of L-neighbouring reconstruction samples, the decoder can guess the partition direction. As shown in FIG. 19, there are two object boundaries (1910 and 1920) cutting through the top edge and the bottom edge of the current block 1900. By content analysis (in the decoder side), the decoder can determine VBT (as shown by the dashed line 1930) to be a better partition. Therefore, the decoder can implicitly decide the BT to be VBT, instead of HBT.

### Proposed Method D: Joint-Deblocking Based DIMD

In the proposed method, it uses deblocking to make the DIMD more accurate. The pixels of L-shape neighbouring samples and the internal CU samples may have block effects. In order to improve the accuracy of the angle prediction of DIMD, it is proposed to apply the deblocking across the CU-boundary.

An example of the process is shown as follows:
Step 1: use DIMD to get angle and then apply intra-prediction for internal CU samples.
Step 2: add residual to the internal CU samples to generate some fake reconstruction samples.
Step 3: do deblocking across the CU boundary (between outer L-shape reconstructed samples and internal CU fake reconstructed samples).
Step 4: do DIMD again for a more accurate angle

### Proposed Method E: Neighbour-CU Deblocking-Processed TIMD/DIMD

In the proposed method, it can pre-apply deblocking onto the L-neighbouring region (i.e., outside the current CU) so as to make the DIMD or TIMD more accurate.

Before doing DIMD or TIMD, the L-neighbouring region (i.e., outside the current CU) will be firstly filtered by the deblocking filter.

The basic idea behind this method is that the top/left neighbours may have several CUs; among them, there may have several boundary-effects; therefore, it will make DIMD/TIMD not so accurate. Accordingly, doing deblocking for neighbour CUs will make surrounding pixels smoother, so as to improve the accuracy of DIMD/TIMD.

### Proposed Method F: Implicitly Choosing Different Edge Filter

In the DIMD flow, one edge filter is used to detect the angle field (or angle histogram) in the L-shape neighbouring region (i.e., outside of the current CU). In conventional DIMD, the edge filter is a fixed size. According to one embodiment of the present invention, more edge filter kernels are defined. It can implicitly select between those pre-defined edge filter kernels by analysing (in the decoder side) the L-neighbouring region samples. In one example, decoder can calculate pixel variance for the neighbouring pixels

If the variance is small, this implies that content is smooth. Accordingly, a larger kernel for the edge filter is chosen for this case.

If the variance is large, this implies that content is not smooth. Accordingly, a smaller kernel for the edge filter is chosen for this case.

### Proposed Method G: Edge Filter Selection

In the DIMD flow, one edge filter is used to detect the angle field (or, angle histogram) in the L-shape neighbouring region (i.e., outside of the current CU). In conventional DIMD, the edge filter is a fixed size. According to one embodiment of the present invention, more edge filter kernels are defined.

In another embodiment, the encoder will find the best edge filter kernel and send signals to the decoder to indicate the best edge filter kernel.

In another embodiment, some CUs inside the current CTU will receive the edge filter selection (from the signal sent by the encoder); for other CUs, it can use some (merge-mode-like) inheritance-based method to inherit the edge filter selection from neighbouring CUs.

### Proposed Method H: Multi-Hypothesis

The MH (Multi-Hypothesis) concept is to firstly make at least two predictors (from the same or different coding methods), and then blending those predictors together to achieve a more accurate predictor.

In this new method, we apply MH to DIMD and/or TIMD. In one embodiment, it can apply MH between one or more encoder-sent angle predictors (e.g. the intra-prediction angles judged from the encoder-sent signal) and one or more DIMD (and/or TIMD) generated predictors.

In another embodiment, it can apply MH between one or more TIMD generated predictors and one or more DIMD generated predictors.

In another embodiment, it can apply MH between one or more encoder-sent angle predictors (e.g. the intra-prediction angles judged from the encoder-sent signal) and one or more “DIMD/TIMD-refined-angle predictors” (defined as: firstly receiving intra-angle from the encoder-sent signal; and apply refinement for the angle derived by DIMD or TIMD).

### Proposed Method I: MH for two Angles

In this proposed method, we can apply MH for the intra prediction related to DIMD/TIMD.

In one embodiment, we can apply MH for one predictor from explicitly sent intra-angle and another predictor using a DIMD-derived angle.

In another embodiment, we can apply MH for one predictor from TIMD-derived angle and another predictor using a DIMD-derived angle.

### Proposed Method J: MH for Neighbouring CU for More Template Reference

In this proposed method, the goal is to make the L-neighbouring region samples to be MH processed so as to make the TIMD/DIMD angle more accurate.

The basic concept is that, besides the original L-neighbouring region samples, we can apply MH for the L-shape region and (remove some noise in the L-neighbouring region samples by finding another L-shape samples from other places. Therefore, the angle-prediction from TIMD/DIMD will be more accurate.

In one embodiment, we can search another L-shape region samples in the current picture. According to this embodiment, it uses original L-neighbouring region samples (i.e., surrounding the current CU) as the template, and use the template to search in the current picture to find a best match. After getting the best match (designated as L′), we can apply MH for L (original L-neighbouring region samples surrounding the current CU) and L′. Finally, combine the MH results into a new L-shape, and the DIMD/TIMD will be applied onto the new L-shape.

Exemplary steps for the above process are shown here:
Step 1: use L-shape (L) to do the current-picture search.
Step 2: find best match for the L-shape (in current-picture), denote the best one as L′.
Step 3: apply MH on these two L-shapes (L and L′) to form a new L-shaped region.
Step 4: do TIMD/DIMD based on the new L-shaped region.

In another embodiment, instead of searching through the current picture, we can search the L′ in the reference picture. In other words, the flow is the same as the previous embodiment, except that the L′ is found in the reference picture.

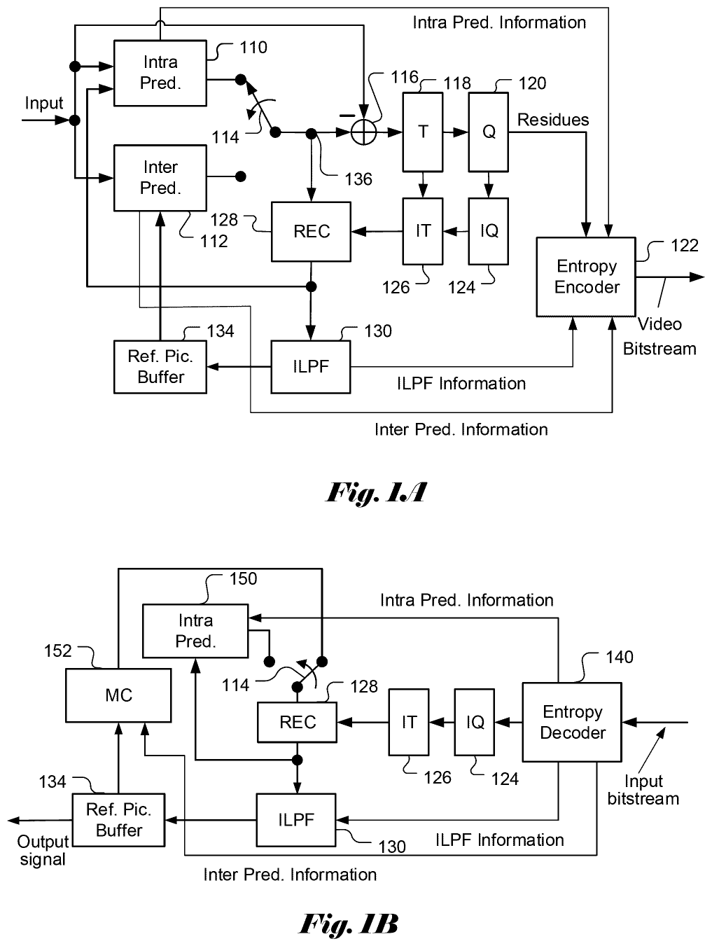

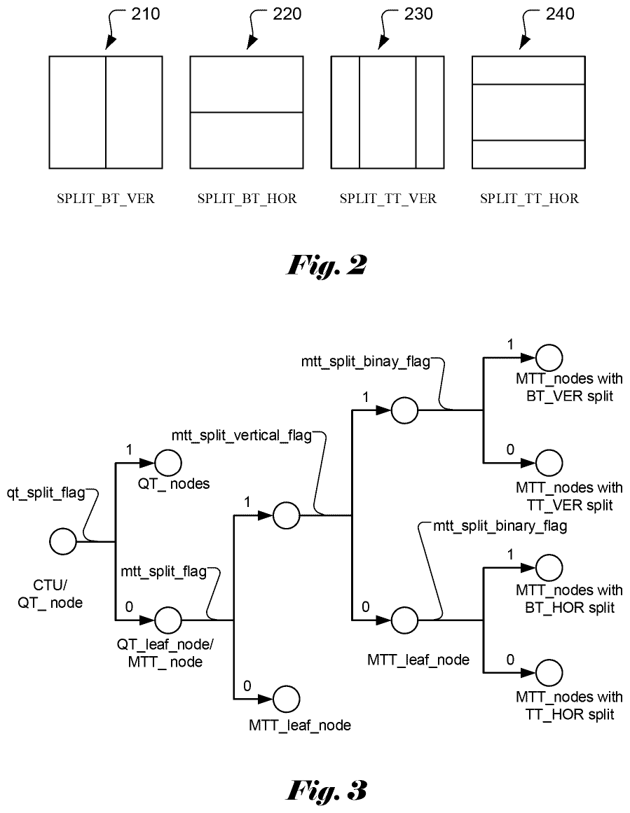

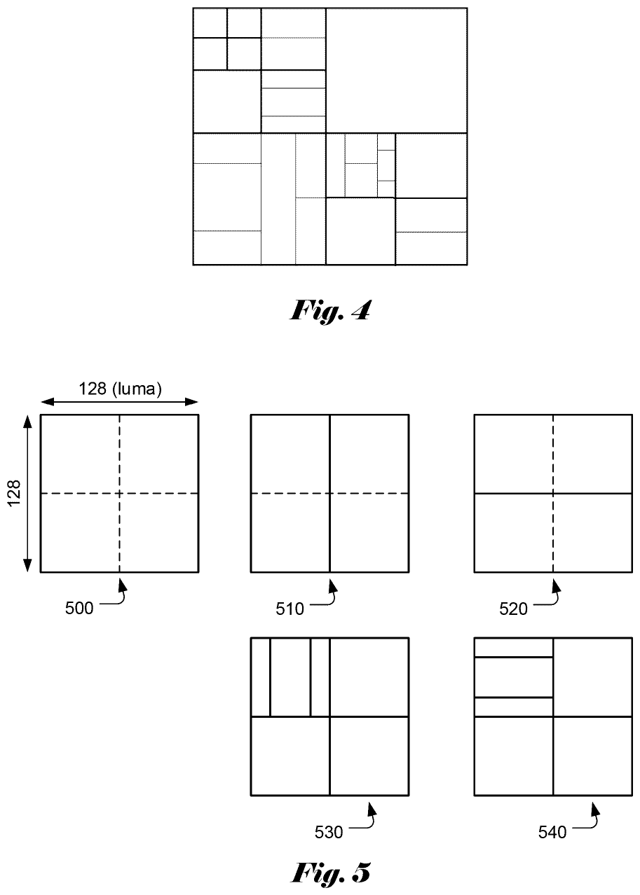

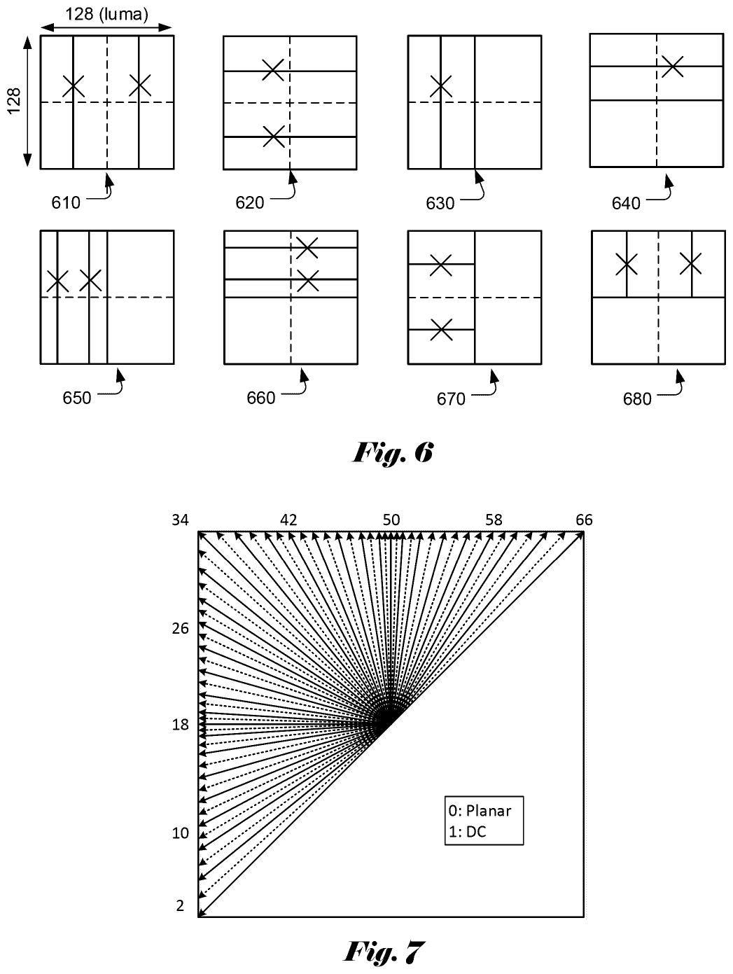

Any of the foregoing proposed using BDPCM (Block Differential Pulse Coded Modulation) methods can be implemented in encoders and/or decoders. For example, any of the proposed methods can be implemented in an intra (e.g. Intra 150 in FIG. 1B)/inter coding module of a decoder, a motion compensation module (e.g. MC 152 in FIG. 1B), a merge candidate derivation module of a decoder. Alternatively, any of the proposed methods can be implemented as a circuit coupled to the intra (e.g. Intra 110 in FIG. 1A)/inter coding module of an encoder and/or motion compensation module (e.g. MC 112 in FIG. 1B), a merge candidate derivation module of the encoder to determine a prediction direction between vertical prediction and horizontal prediction for the current block based on a template of the current block or based on decoder side intra mode derivation using statistics or histogram of angle field derived from the template of the current block.

FIG. 20 illustrates a flowchart of an exemplary video coding system that derives partition mode for BDPCM using TIMD/DIMD according to an embodiment of the present invention. The steps shown in the flowchart may be implemented as program codes executable on one or more processors (e.g., one or more CPUs) at the encoder side. The steps shown in the flowchart may also be implemented based hardware such as one or more electronic devices or processors arranged to perform the steps in the flowchart. According to this method, pixel data associated with a current block at an encoder side or coded data associated with the current block to be decoded at a decoder side are received in step 2010. A prediction direction between vertical prediction and horizontal prediction for the current block is determined based on a template of the current block or based on decoder side intra mode derivation using statistics or histogram of angle field derived from the template of the current block in step 2020. The current block is encoded or decoded using BDPCM (Block Differential Pulse Coded Modulation) in the prediction direction in step 2030.

FIG. 21 illustrates a flowchart of an exemplary video coding system that derives coding parameters related inter-intra GPM using TIMD/DIMD according to an embodiment of the present invention. According to this method, pixel data associated with a current block at an encoder side or coded data associated with the current block to be decoded at a decoder side are received in step 2110. The current block is partitioned into a first region and a second region according to a region split in step 2120. The first region is encoded or decoded based on inter coding in step 2130 and the second region is encoded or decoded according to intra coding in step 2140. For block partitioning, inter coding and intra mentioned above, at least a part of region-spit parameters, a part of inter coding parameters, or a part of intra coding parameters is determined based on a template of the current block or based on decoder side intra mode derivation using statistics or histogram of angle field derived from the template of the current block in step 2150.

The flowcharts shown are intended to illustrate an example of video coding according to the present invention. A person skilled in the art may modify each step, re-arranges the steps, split a step, or combine steps to practice the present invention without departing from the spirit of the present invention. In the disclosure, specific syntax and semantics have been used to illustrate examples to implement embodiments of the present invention. A skilled person may practice the present invention by substituting the syntax and semantics with equivalent syntax and semantics without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more circuit circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of video coding, the method comprising:
receiving pixel data associated with a current block at an encoder side or coded data associated with the current block to be decoded at a decoder side;
determining a prediction direction between vertical prediction and horizontal prediction for the current block based on a template of the current block or based on decoder side intra mode derivation using statistics or histogram of angle field derived from the template of the current block; and
encoding or decoding the current block using BDPCM (Block Differential Pulse Coded Modulation) in the prediction direction.

2. The method of claim 1, wherein the template comprises one or more sample lines in a neighbouring region of the current block.

3. A method of video coding, the method comprising:
receiving pixel data associated with a current block at an encoder side or coded data associated with the current block to be decoded at a decoder side;
partitioning the current block into a first region and a second region according to a region split;
encoding or decoding the first region based on inter coding; and
encoding or decoding the second region according to intra coding; and
wherein at least a part of region-spit parameters, a part of inter coding parameters, or a part of intra coding parameters is determined based on a template of the current block or based on decoder side intra mode derivation using statistics or histogram of angle field derived from the template of the current block.

4. The method of claim 3, wherein the template comprises one or more sample lines in a neighbouring region of the current block.

5. The method of claim 3, wherein a motion vector for the inter coding is derived using the template of the current block.

6. The method of claim 3, wherein an intra-prediction angle for the intra coding is derived using the template of the current block or the decoder side intra mode derivation.

7. The method of claim 3, wherein a partition boundary offset related to the region split is derived using the template of the current block.

8. The method of claim 7, wherein information for a partition-boundary slope related to the region split is signalled in a bitstream at the encoder side.

9. The method of claim 7, wherein information for a partition-boundary slope related to the region split is parsed from a bitstream at the decoder side.

10. An apparatus for video coding, the apparatus comprising one or more electronics or processors arranged to:
receive pixel data associated with a current block at an encoder side or coded data associated with the current block to be decoded at a decoder side;
determine a prediction direction between vertical prediction and horizontal prediction for the current block based on a template of the current block or based on decoder side intra mode derivation using statistics or histogram of angle field derived from the template of the current block; and
encode or decode the current block using BDPCM (Block Differential Pulse Coded Modulation) in the prediction direction.

11. An apparatus for video coding, the apparatus comprising one or more electronics or processors arranged to:
receive pixel data associated with a current block at an encoder side or coded data associated with the current block to be decoded at a decoder side;
partition the current block into a first region and a second region according to a region split;
encode or decode the first region based on inter coding; and
encoding or decoding the second region according to intra coding; and
wherein at least a part of region-spit parameters, a part of inter coding parameters, or a part of intra coding parameters is determined based on a template of the current block or based on decoder side intra mode derivation using statistics or histogram of angle field derived from the template of the current block.
